(19) United States
(12) Patent Application Publication
(10) Pub. No.: US 2004/0123461 A1
(43) Pub. Date: Jul. 1, 2004

(54) Method for making a gear with 90-180 teeth

(76) Inventor: Chih-Ching Hsien, Taichung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/331,461

(22) Filed: Dec. 31, 2002

(51) Int. Cl. B23P 15/14

(52) U.S. Cl. 29/893.34

(57) ABSTRACT

A method for making a gear with 90-180 teeth includes step 1 of forging an initial product of the gear; step 2 of annealing the initial product of the gear; step 3 of trimming the initial product of the gear; step 4 of grinding the initial product of the gear; step 5 of rolling the initial product of the gear to have 90 to 180 teeth; step 6 of proceeding the gear in step 5 with a heat treatment; and step 7 of proceeding the gear in step 6 with surface treatment.

### FIELD OF THE INVENTION

The present invention relates to a method for making a gear with 90 to 180 teeth.

### BACKGROUND OF THE INVENTION

A conventional ratchet wrench 1 as shown in FIG. 1 generally includes a head 100 with an engaging ring 1′ engaged with a hole 101 in the head 100 and the engaging ring 1′ includes a polygonal hole so as to mount onto a nut or a bolt head. A pawl 102 is movably received in the head 100 and engaged with the teeth defined in an outer periphery of the engaging ring 1′ such that the engaging ring 1′ can be maintained stationary relative to the rotation of the wrench 1, or co-rotatable with the rotation of the wrench 1. Nevertheless, the number of the teeth of the engaging ring 1′ is generally 72 and there is a gap between the teeth of the engaging ring 1′ and the pawl so that a small angle that the handle is rotated at the beginning of rotation actually does not match the teeth of the engaging ring to the pawl.

The present invention intends to provide a method that is able to manufacture a gear having 90 to 180 teeth so that the teeth of the engaging ring and the pawl can be matched with each other even the wrench is rotated a small angle.

### SUMMARY OF THE INVENTION

In accordance with one aspect of the present invention, there is provided a method for making a gear with 90-180 teeth and the method includes step 1 of forging an initial product of the gear; step 2 of annealing the initial product of the gear; step 3 of trimming the initial product of the gear; step 4 of grinding the initial product of the gear; step 5 of rolling the initial product of the gear to have 90 to 180 teeth; step 6 of proceeding the gear in step 5 with a heat treatment; and step 7 of proceeding the gear in step 6 with surface treatment.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show a conventional ratchet wrench;

FIG. 2 shows steps of method for making the gear with 90-180 teeth;

FIG. 3 shows the initial product of the gear;

FIG. 4 shows the initial product of the gear is proceeded by way of center grinding;

FIG. 5 shows the initial product of the gear is proceeded by way of centerless grinding;

FIG. 6 shows the initial product of the gear is proceeded by way of rolling;

FIG. 7 is a perspective view to show the final product of the gear;

FIGS. 8 to 11 show gears with different types of teeth made by the method of the present invention.

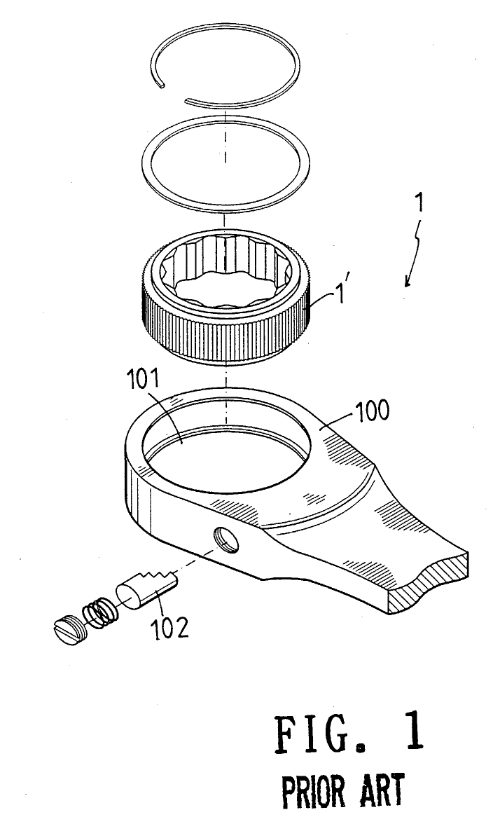

### DETAILED DESCRIPTION OF THE PREFERRED EMBODIMENT

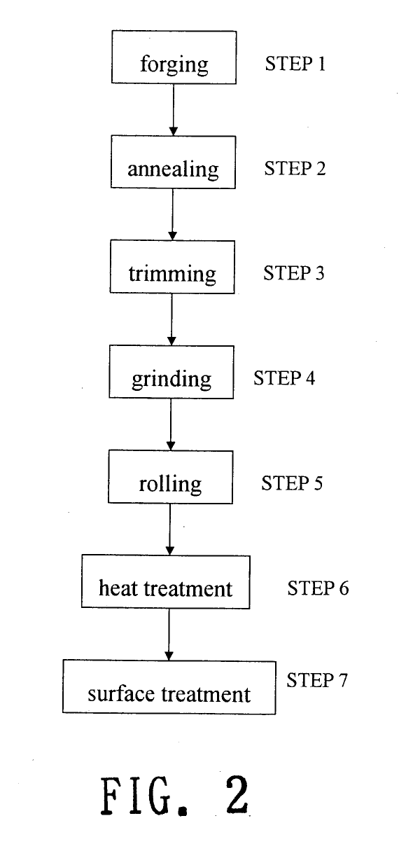

Referring to FIG. 2, the method for making the gear with 90 to 180 teeth includes the following steps which are:

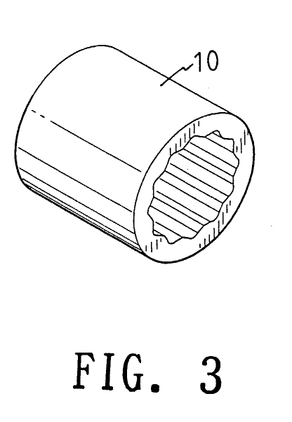

step 1: forging an initial product of the gear 10 as shown in FIG. 3;

step 2: annealing the initial product of the gear twice preferably to release the stress due to the forging process;

step 3: trimming the initial product of the gear 10 by using a lather so as to be the second stage product of the gear 12;

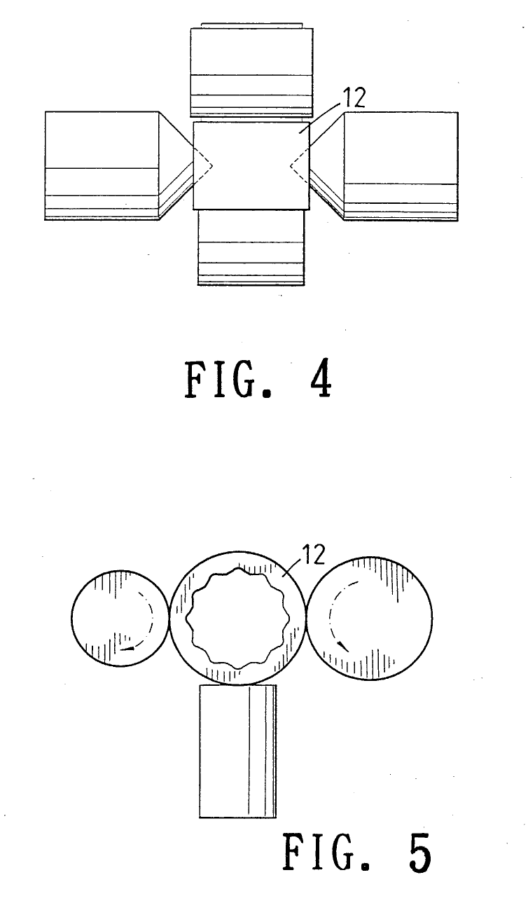

step 4: grinding the initial product of the gear 10 by way of center grinding or centerless grinding as shown in FIGS. 4 and 5 so as to obtain a precision of 1μ to 5μ;

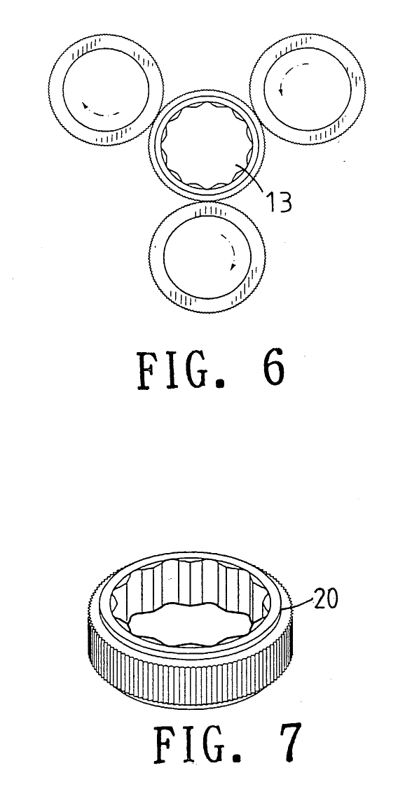

step 5: rolling the second stage product of the gear 12 to be a third stage product of the gear 13 having 90 to 180 teeth as shown in FIG. 6;

step 6: proceeding the gear 13 in step 5 by a heat treatment; and

step 7: proceeding the gear 13 in step 6 with surface treatment so as to be the final product 20 as shown in FIG. 7.

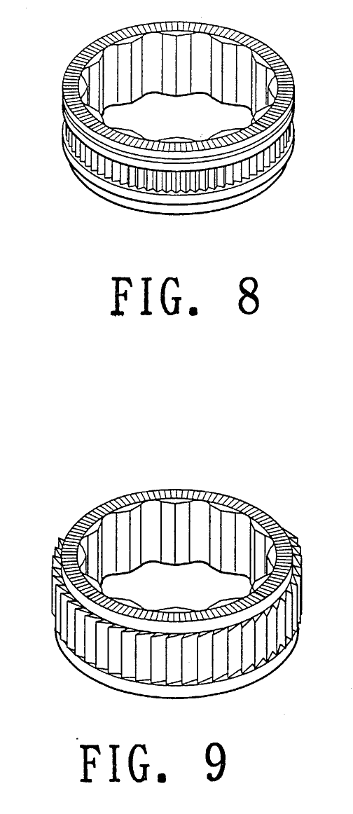

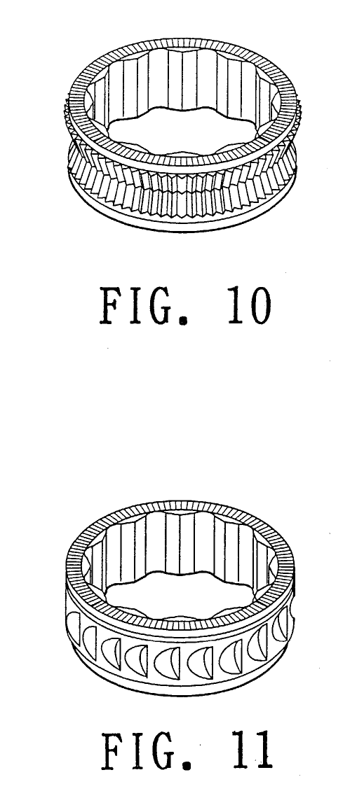

The types and shapes of the teeth of the gear can be varied according to needs and FIGS. 8 to 11 show some examples of the teeth of the gear.

While we have shown and described the embodiment in accordance with the present invention, it should be clear to those skilled in the art that further embodiments may be made without departing from the scope of the present invention.

What is claimed is:

1. A method for making a gear with 90-180 teeth, comprising:
step 1: forging an initial product of the gear;
step 2: annealing the initial product of the gear;
step 3: trimming the initial product of the gear;
step 4: grinding the initial product of the gear;
step 5: rolling the initial product of the gear to have 90 to 180 teeth;
step 6: proceeding the gear in step 5 with a heat treatment; and
step 7: proceeding the gear in step 6 with surface treatment.
